(19) United States
(12) Patent Application Publication
(10) Pub. No.: US 2026/0016322 A1
(43) Pub. Date: Jan. 15, 2026

(54) POSITION DETECTION DEVICE

(71) Applicant: Proterial, Ltd., Tokyo (JP)

(72) Inventors: Yoshiaki YANAGISAWA, Tokyo (JP); Yohei SHIRAKAWA, Tokyo (JP)

(73) Assignee: Proterial, Ltd., Tokyo (JP)

(21) Appl. No.: 19/235,087

(22) Filed: Jun. 11, 2025

(30) Foreign Application Priority Data
Jul. 11, 2024 (JP) 2024-111901

(51) Int. Cl. G01D 5/20; B62D 5/00; B62D 15/02

(52) U.S. Cl. CPC G01D 5/20; B62D 15/0225; B62D 5/001; B62D 15/022

(57) ABSTRACT

A position detection device for detecting the position of a shaft that moves forward and backward in the axial direction in a predetermined range includes an excitation coil that generates an alternating current magnetic field, a detection target fixed to the shaft and in which the magnetic flux of the alternating current magnetic field is chained together, and a detection coil in which the magnetic flux of the alternating current magnetic field is chained together, wherein the detection coil has first to fourth portions where an induced voltage is induced by the magnetic flux of the alternating current magnetic field chained together, and connection portions connecting the first to fourth portions, wherein the first to fourth portions each extend along the coil longitudinal direction which is parallel to the axial direction, and at least a portion of each is aligned perpendicular to the coil longitudinal direction, wherein the detection target has a first detection target portion at least partially facing the first portion in the first predetermined range of the predetermined range, a second detection target portion at least partially facing the second portion in the second predetermined range of the predetermined range, a third detection target portion at least partially facing the third portion in the third predetermined range of the predetermined range, and a fourth detection target portion at least partially facing the fourth portion in the fourth predetermined range of the predetermined range, wherein the induced voltage induced in the first to fourth portions varies with the position of the first to fourth detection target portions relative to the first to fourth portions respectively, and wherein the first detection target portion, the second detection target portion, the third detection target portion, and the fourth detection target portion are spaced apart in the axial direction of the shaft.

### CROSS-REFERENCE TO RELATED APPLICATIONS

The present patent application claims the priority of Japanese patent application No. 2024-111901 filed on Jul. 11, 2024, the entire contents of which are incorporated herein by reference.

### TECHNICAL FIELD

This invention relates to a position detection device for detecting the position of a shaft that moves forward and backward in an axial direction.

### BACKGROUND TECHNOLOGY

Conventionally, position detection devices for detecting the position of a shaft that moves forward and backward in the axial direction are used, for example, to detect the position of a rack shaft in a vehicle steering system. The applicant of the present invention has proposed such a position detection device as described in Patent Literature 1.

The position detection device described in Patent Literature 1 has a target attached to the rack shaft, an excitation coil that generates an alternating current magnetic field, and two detection coils positioned along the axial direction of the rack shaft. The excitation coil and the two detection coils are formed as a wiring pattern on a single substrate. When the two detection coils are viewed from a direction perpendicular to the substrate, one detection coil has a shape that combines a pair of waveform conductor wires in a sine waveform, while the other detection coil has a shape that combines a pair of waveform conductor wires in a cosine waveform. When the rack shaft moves, the magnitude of the induced voltage induced in each of the two detection coils changes according to the position of the target. Therefore, the position of the rack shaft can be detected by the magnitude of the induced voltage.

### CITATION LIST

Patent Literature 1: JP2023-117379A

### SUMMARY OF THE INVENTION

In the position detection device configured as described above, if the rack shaft tilts against the substrate due to, for example, vibration caused by vehicle driving, the distance between the rack shaft and target and the substrate may change, which may easily cause a detection error. Therefore, the purpose of the present invention is to provide a position detection device capable of detecting with higher accuracy the position of a shaft that moves forward and backward in the axial direction.

For the purpose of solving the above problem, the present invention provides a position detection device for detecting the position of a shaft that moves forward and backward in an axial direction in a predetermined range, comprising:
an excitation coil that generates an alternating current magnetic field;
a detection target fixed to the shaft and in which the magnetic flux of the alternating current magnetic field is chained together; and
a detection coil in which the magnetic flux of the alternating current magnetic field is chained together,
wherein the detection coil has first to fourth portions where an induced voltage is induced by the magnetic flux of the alternating current magnetic field chained together, and connection portions connecting the first to fourth portions,
wherein the first to fourth portions each extend along a coil longitudinal direction which is parallel to the axial direction, and at least a portion of each is aligned perpendicular to the coil longitudinal direction,
wherein the detection target has a first detection target portion at least partially facing the first portion in a first predetermined range of the predetermined range, a second detection target portion at least partially facing the second portion in a second predetermined range of the predetermined range, a third detection target portion at least partially facing the third portion in a third predetermined range of the predetermined range, and a fourth detection target portion at least partially facing the fourth portion in a fourth predetermined range of the predetermined range,
wherein the induced voltage induced in the first to fourth portions varies with the position of the first to fourth detection target portions relative to the first to fourth portions respectively, and
wherein the first detection target portion, the second detection target portion, the third detection target portion, and the fourth detection target portion are spaced apart in the axial direction of the shaft.

### Advantageous Effects of the Invention

According to the position detection device of the present invention, it is possible to suppress detection errors caused by inclination of a shaft and to detect the shaft position with high accuracy.

### BRIEF DESCRIPTION OF THE DRAWINGS

FIG. 1 is a schematic diagram of a vehicle equipped with a steer-by-wire steering system with a stroke sensor as a position detection device according to an embodiment of the present invention.

FIG. 2 is a sectional view taken along the line A-A in FIG. 1.

FIG. 3A is a diagram showing the rack shaft, a housing body, the detection target, and the substrate.

FIG. 3B is a configuration view of the rack shaft and the detection target from a direction perpendicular to the center axis of the rack shaft.

FIG. 4A and FIG. 4B are explanatory diagrams illustrating the two detection coils respectively.

FIG. 5 is an explanatory diagram illustrating the excitation coil and the two detection coils.

FIG. 6A to FIG. 6E are explanatory diagrams illustrating the relative positional changes between the two detection coils and the first to fourth detection targets when the rack shaft moves from the right side to the left side of the drawing with respect to the substrate.

FIG. 7 is a graph showing an example of the relationship between the supply voltage supplied from the power supply unit to the excitation coil and the induced voltage induced in the two detection coils when the first detection target portion is facing the first portion of the two detection coils.

FIG. 8 is a graph showing the relationship between a peak voltage, which is a peak value of the induced voltage induced in a first detection coil, and the position of the detection target.

FIG. 9 is a graph showing the relationship between the peak voltage, which is the peak value of the induced voltage induced in a second detection coil, and the position of the detection target.

FIG. 10A is an explanatory diagram schematically showing the relationship between the inclination of the rack shaft relative to the substrate and the effect of the inclination of the rack shaft on the magnetic flux density chained to the first detection coil.

FIG. 10B is an explanatory diagram schematically showing the relationship between the inclination of the rack shaft relative to the substrate and the effect of the inclination of the rack shaft on the magnetic flux density chained to the second detection coil.

FIG. 11 is a graph showing the evaluation results of detection errors when the position of the rack shaft is detected by the stroke sensor according to the embodiment of the present invention.

### DETAILED DESCRIPTION OF THE INVENTION

### Embodiment

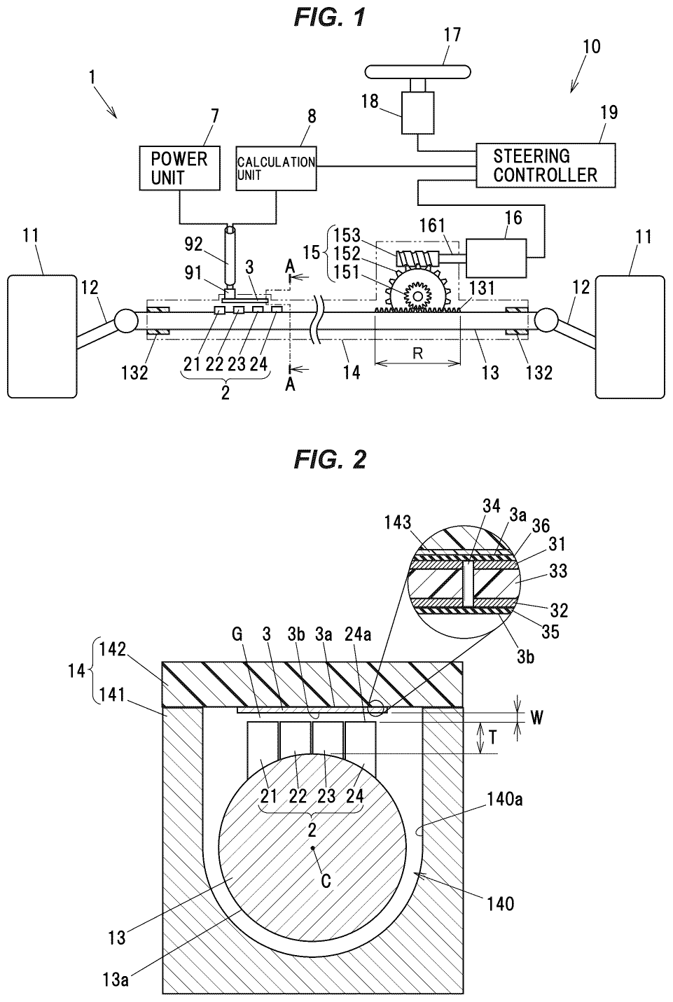

FIG. 1 is a schematic diagram of a vehicle equipped with a steer-by-wire steering system 10 with a stroke sensor 1 as a position detection device according to an embodiment of the present invention.

As shown in FIG. 1, the steering system 10 consists of a stroke sensor 1, tie rods 12 connected to steering wheels 11 (right and left front wheels), a metal rack shaft 13 connected to the tie rods 12, a cylindrical housing 14 accommodating the rack shaft 13, a worm reduction mechanism 15 having a pinion gear 151 meshed with rack teeth 131 of the rack shaft 13, an electric motor 16 that applies a moving force in the vehicle width direction to the rack shaft 13 via the worm reduction mechanism 15, a steering wheel 17 operated by a driver, a steering angle sensor 18 that detects the steering angle of the steering wheel 17, and a steering controller 19 that controls the electric motor 16 based on the steering angle detected by the steering angle sensor 18.

In FIG. 1, the housing 14 is shown as a virtual line. The rack shaft 13 is, for example, made of steel such as carbon steel, and is supported by a pair of rack bushings 132 attached to the both ends of the housing 14. The worm reduction mechanism 15 has a worm wheel 152 and a worm gear 153, as well as the pinion gear 151 fixed to the worm wheel 152. The worm gear 153 is fixed to the motor shaft 161 of the electric motor 16.

The electric motor 16 generates torque by the motor current supplied by the steering controller 19 and rotates the worm wheel 152 and the pinion gear 151 via the worm gear 153. As the pinion gear 151 rotates, the rack shaft 13 moves and the left and right steering wheels 11 are steered. The rack shafts 13 can move from a neutral position when the steering angle is zero to the right and left sides in the vehicle width direction. In FIG. 1, a predetermined range R within which the rack shaft 13 can move in the vehicle width direction is indicated by both arrows.

### (Configuration of Stroke Sensor 1)

The stroke sensor 1 has a detection target 2 fixed to the rack shaft 13, a substrate 3 positioned opposite the detection target 2 and parallel to the rack shaft 13, a power supply unit 7, and a calculation unit 8. The substrate 3, the power supply unit 7, and the calculation unit 8 are connected by a connector 91 and a cable 92 attached to the substrate 3. The substrate 3 is fixed inside the housing 14, parallel to the rack shaft 13. The stroke sensor 1 detects the position of the rack shaft 13 relative to the housing 14 by the position of the detection target 2 and outputs the data on the detected position to the steering controller 19. The steering controller 19 controls the electric motor 16 so that the position of the rack shaft 13 detected by the stroke sensor 1 is in accordance with the steering angle of the steering wheel 17 detected by the steering angle sensor 18.

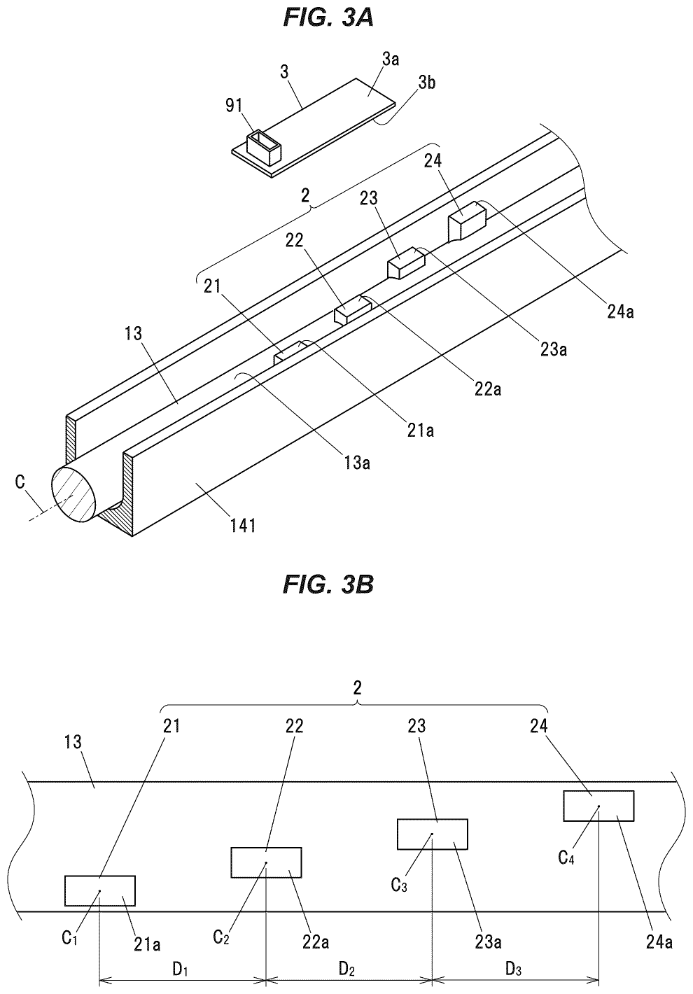

FIG. 2 is a sectional view taken along the line A-A in FIG. 1. FIG. 3A is a diagram showing the rack shaft 13, a body 141 of the housing 14, the detection target 2, and the substrate 3. In FIG. 3A, a central axis line C of the rack shaft 13 is shown as a dash-dotted line. FIG. 3B shows the rack shaft 13 and detection target 2 viewed from a direction perpendicular to the central axis line C. The rack shaft 13 moves along the central axis line C by the moving force imparted by the electric motor 16. The direction parallel to the center axis line C of the rack shaft 13 is hereinafter referred to as the “axial direction.”

The rack shaft 13 is a rod-shaped body made of steel with a circular cross section and moves forward and backward in the axial direction in the predetermined range R in FIG. 1. The housing 14 has the metal body 141 and a plastic lid 142, and the lid 142 is fixed to the body 141, for example, by adhesion or bolting. The body 141 has a U-shaped cross section with a housing space 140 for housing the rack shaft 13, and the housing space 140 is open upward in the vertical direction.

Between the outer surface 13a of the rack shaft 13 and the inner surface 140a of the housing space 140, a gap of, for example, 1 mm or more is formed. The lid 142 covers the top of the housing space 140 (vertically above). The body 141 is nonmagnetic and is made of, for example, die-cast formed aluminum alloy. Also, a material for the lid 142 is not necessarily limited to resin, but it is desirable to be nonmagnetic and nonconductive.

The detection target 2 has a first detection target portion 21, a second detection target portion 22, a third detection target portion 23, and a fourth detection target portion 24. In the examples shown in FIG. 2 and FIG. 3A, FIG. 3B, the first detection target portion 21, the second detection target portion 22, the third detection target portion 23, and the fourth detection target portion 24 are separate bodies, and each is individually attached to the rack shaft 13. The first detection target portion 21, the second detection target portion 22, the third detection target portion 23, and the fourth detection target portion 24 are spaced apart at regular intervals in the axial direction of the rack shaft 13.

The first detection target portion 21, the second detection target portion 22, the third detection target portion 23, and the fourth detection target portion 24 are fixed to the rack shaft 13 by welding, for example, so that they project from the outer surface 13a of the rack shaft 13 toward the substrate 3. However, not limited to this, but a plate-shaped base member having the first detection target portion 21, the second detection target portion 22, the third detection target portion 23, and the fourth detection target portion 24 in a single piece may be attached to the rack shaft 13 and used as the detection target, for example.

The first to fourth detection target portions 21 to 24 of the detection target 2 are made of a material with a higher magnetic permeability than that of the rack shaft 13 or a material with a higher electrical conductivity than that of the rack shaft 13. When using a material with higher magnetic permeability than that of the rack shaft 13 for the first to fourth detection target portions 21 to 24, it is desirable to use a magnetic material such as ferrite, which has high electrical resistance and is less likely to generate eddy currents. Also, when using a material with higher conductivity than that of the rack shaft 13 for the first to fourth detection target portions 21 to 24, for example, a metal mainly composed of aluminum or copper can be used as the material.

Since the first to fourth detection target portions 21 to 24 protrude from the outer surface 13a of the rack shaft 13 toward the substrate 3 in the present embodiment, even if a material with equal magnetic permeability to the rack shaft 13 or a material with equal electrical conductivity to the rack shaft 13 is used as the material for the detection target 2, the functions and effects described below can be obtained. However, in order to increase the accuracy of position detection, it is desirable to use a high magnetic permeability material with a higher magnetic permeability than the material of the rack shaft 13 or a high conductivity material with an equal conductivity to the material of the rack shaft 13 as the material of the first to fourth detection target portions 21 to 24.

The facing surfaces 21a, 22a, 23a, and 24a of the first to fourth detection target portions 21 to 24, which face the substrate 3, are formed in a flat shape and face parallel to the back surface 3b of the substrate 3 with an air gap G between them. The front surface 3a of the substrate 3 is fixed to the lid 142 by means of an adhesive 143. The shape of the facing surfaces 21a, 22a, 23a, and 24a of the first to fourth detection target portions 21 to 24, viewed from the substrate 3 side, is rectangular which is long in the axial direction.

A width W of the air gap G is, for example, 1 mm. A minimum thickness T of the first to fourth detection target portions 21 to 24 in the direction perpendicular to the facing surfaces 21a, 22a, 23a, and 24a of the first to fourth detection target portions 21 to 24 is, for example, 5 mm. In the present embodiment, the rack shaft 13 is circular in cross-section, but the cross-sectional shape of the rack shaft 13 is not limited to circular, but may be, for example, D-shaped with a portion formed in a straight line, or polygonal.

The substrate 3 has a rectangular shape whose long side is along the axial direction of the rack shaft 13. As shown in FIG. 2, when viewing the first to fourth detection target portions 21 to 24 from the axial direction of the rack shaft 13, there is a small gap in the shortitudinal direction of the substrate 3 between the first detection target portion 21 and the second detection target portion 22, between the second detection target portion 22 and the third detection target portion 23, and between the third detection target portion 23 and the fourth detection target portion 24.

In the present embodiment, the substrate 3 is a two-layer substrate having a first wiring layer 31, a second wiring layer 32, and a base material 33 between the first wiring layer 31 and the second wiring layer 32. Wiring patterns are formed in the first wiring layer 31 and the second wiring layer 32, and the wiring pattern of the first wiring layer 31 and the wiring pattern of the second wiring layer 32 are connected by a via hole 34 at multiple locations. The first wiring layer 31 and the second wiring layer 32 are covered with resist films 35 and 36 having electrical insulation properties, respectively. The base material 33 is a flat plate made of a dielectric such as FR4 (glass fiber impregnated with epoxy resin and thermoset).

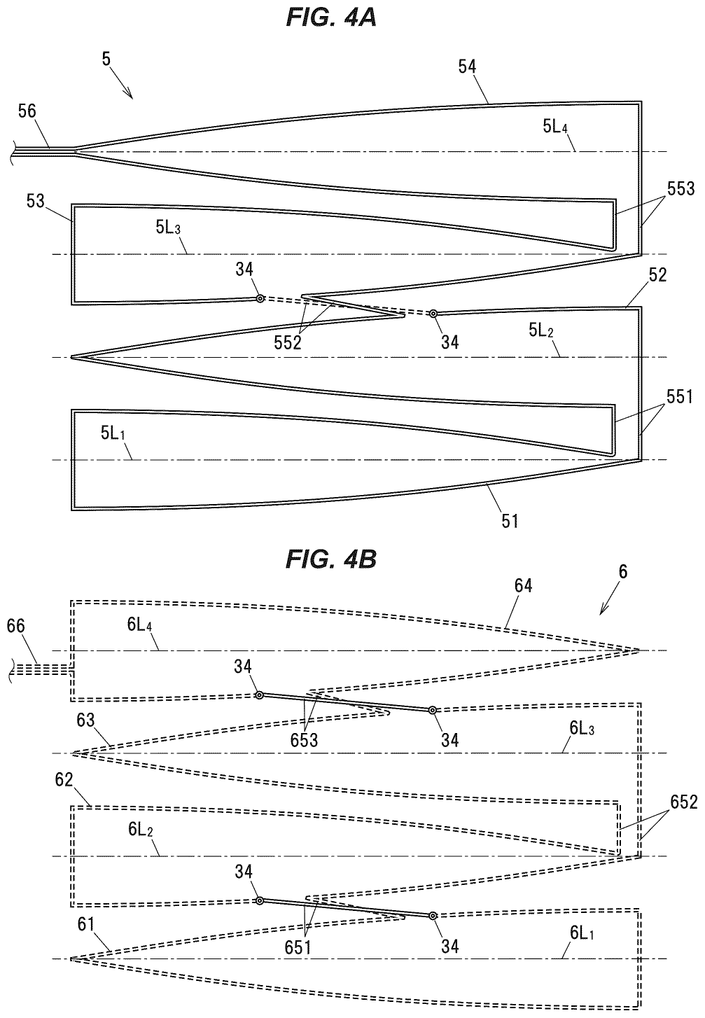

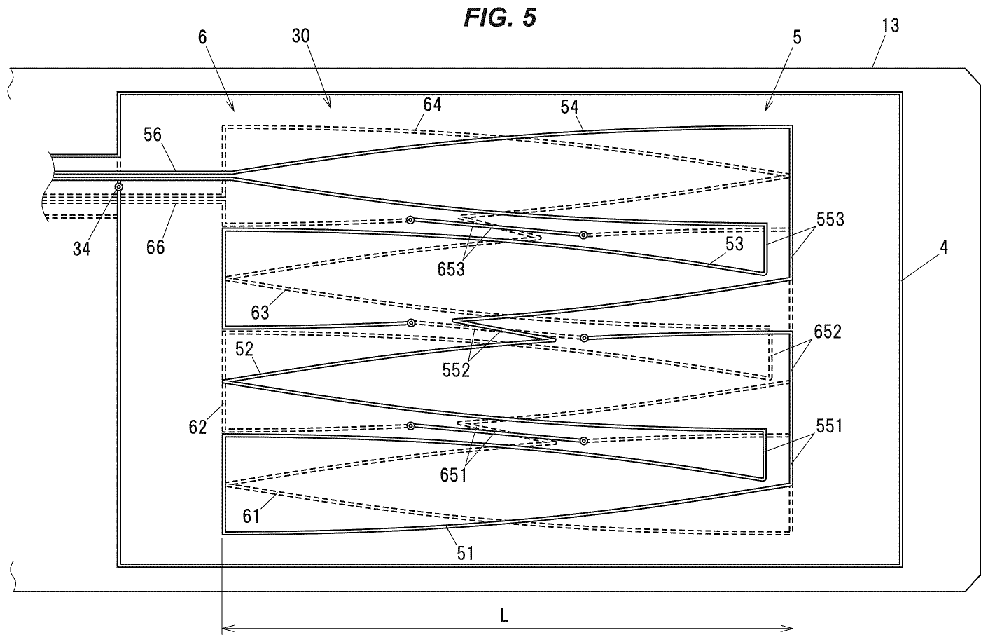

Next, the wiring configuration in the substrate 3 will be explained with reference to FIG. 4A, FIG. 4B and FIG. 5. In FIG. 4A, FIG. 4B, and FIG. 5, the left and right (horizontal) directions of the drawings correspond to the longitudinal direction of the substrate 3. In the substrate 3, an excitation coil 4 that generates an alternating current magnetic field by an alternating current supplied from the power supply unit 7, and two detection coils 5, 6 in which the magnetic flux of the alternating current magnetic field generated by the excitation coil 4 is chained together, are formed by the wiring patterns of the first wiring layer 31 and the second wiring layer 32. However, the wiring patterns in FIG. 4A, FIG. 4B and FIG. 5 are shown as examples, and as long as the substrate 3 is formed so that the effects of the invention can be obtained, various forms of wiring patterns can be employed.

FIG. 4A shows the detection coil 5 of the two detection coils 5, 6. FIG. 4B shows the other detection coil 6 of the two detection coils 5, 6. FIG. 5 shows the excitation coil 4 and the two detection coils 5, 6. FIG. 4A, FIG. 4B, and FIG. 5 show the shape of the excitation coil 4 and the two detection coils 5, 6 viewed from the surface 3a side of the substrate 3. The portion formed of the wiring pattern of the first wiring layer 31 is shown in solid lines and the portion formed of the wiring pattern of the second wiring layer 32 in dashed lines.

Hereinafter, one detection coil 5 shown in FIG. 4A is referred to as the “first detection coil 5” and the other detection coil 6 shown in FIG. 4B is referred to as the “second detection coil 6.” The first detection coil 5 and the second detection coil 6 are stacked in the thickness direction of the substrate 3. The excitation coil 4 is configured in a rectangular shape so as to surround the first detection coil 5 and the second detection coil 6. The excitation coil 4 is configured over the first wiring layer 31 and the second wiring layer 32, and a portion formed in the first wiring layer 31 and a portion formed in the second wiring layer 32 are connected by the via hole(s) 34 and overlapped in the thickness direction of the substrate 3.

The magnetic flux of the AC magnetic field generated by the excitation coil 4 is chained to the first to fourth detection target portions 21 to 24 of the detection target 2 in addition to the first detection coil 5 and the second detection coil 6. The magnetic fluxes chained to the first to fourth detection target portions 21 to 24 affect the intensity distribution of the magnetic fluxes chained to the first detection coil 5 and the second detection coil 6, and the magnitude of the induced voltage induced in the first detection coil 5 and the second detection coil 6 by the AC magnetic field generated by the excitation coil 4 varies depending on the position of the first to fourth detection target portions 21 to 24 relative to the substrate 3.

More specifically, when the first to fourth detection target portions 21 to 24 are made of a material with higher magnetic permeability than that of the rack shaft 13, the magnetic flux flows in a concentrated manner in the first to fourth detection target portions 21 to 24. Thus, the magnetic flux density in the portion of the substrate 3 facing the first to fourth detection target portions 21 to 24 is higher than in other portions. Also, when the first to fourth detection target portions 21 to 24 are made of a material with higher conductivity than that of the rack shaft 13, the eddy currents generated in the first to fourth detection target portions 21 to 24 by the AC magnetic field cause the magnetic flux density in the portion of the substrate 3 facing the first to fourth detection target portions 21 to 24 to be lower than the other portions. As a result, the magnitude of the induced voltage induced in the first detection coil 5 and the second detection coil 6 varies depending on the position of the first to fourth detection target portions 21 to 24 relative to the substrate 3.

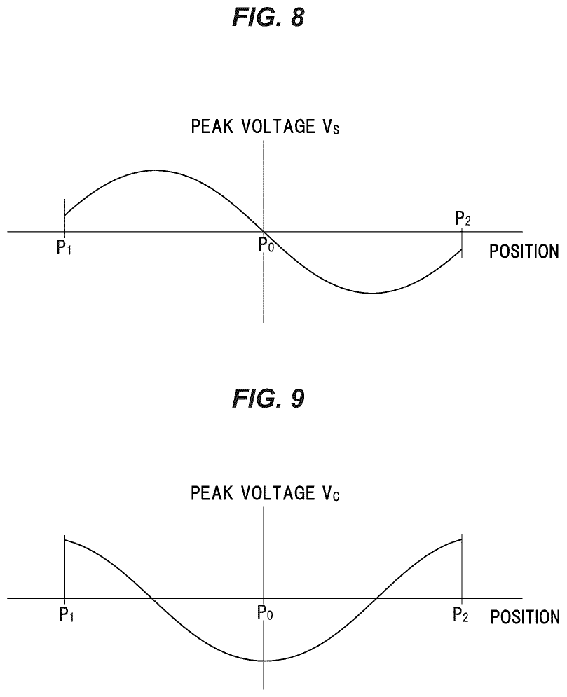

The phases of the induced voltages induced in the first detection coil 5 and the second detection coil 6 respectively while the rack shaft 13 moves from a moving end on one side of the axial direction to a moving end on the other side of the axial direction in the predetermined range R in FIG. 1, are different from each other (see FIG. 8 and FIG. 9 described below). In the present embodiment, the phases of the induced voltages induced in the first detection coil 5 and the second detection coil 6 differ by 90°. Also, while the rack shaft 13 moves from one end of the predetermined range R to the other end, the magnitude of the induced voltage induced in the first detection coil 5 and the second detection coil 6 changes in the range of one cycle or less.

The first detection coil 5 has a first portion 51, a second portion 52, a third portion 53, and a fourth portion 54, in which an induced voltage is induced by the magnetic flux of the alternating current magnetic field of the excitation coil 4 chaining together, connection portions 551 to 553 which connect the first to fourth portions 51 to 54, and an output line portion 56 which outputs the induced voltage induced in the first detection coil 5. Each of the first to fourth portions 51 to 54 extends along the coil longitudinal direction which is parallel to the axial direction of the rack shaft 13, and at least a portion of each is aligned perpendicular to the coil longitudinal direction. In the present embodiment, the first to fourth portions 51 to 54 are equal in length in the coil longitudinal direction, and the entire first to fourth portions 51 to 54 in the coil longitudinal direction are aligned in a row perpendicular to the coil longitudinal direction.

The respective shapes of the first portion 51, the second portion 52, the third portion 53, and the fourth portion 54 of the first detection coil 5, viewed from a direction perpendicular to the substrate 3, are a pair of curved conductor wires with a quarter-wavelength sine wave (one wavelength is equal to the length of the predetermined range R), which are combined in line symmetry across an axis of symmetry along the coil longitudinal direction. In FIG. 4A, these axes of symmetry 5L₁, 5L₂, 5L₃, and 5L₄ are shown as single dotted lines.

When the first detection coil 5 is viewed from the right side of the drawing in FIG. 4A toward the left side of the drawing, the first portion 51 and third portion 53 gradually become wider in the width direction perpendicular to the coil longitudinal direction, while the second portion 52 and the fourth portion 54 gradually become narrower in the width direction perpendicular to the coil longitudinal direction. The shape of the first portion 51, the second portion 52, the third portion 53, and the fourth portion 54 when arranged in a row along the coil longitudinal direction is a sine wave as a whole.

In the first detection coil 5, because the conductor wires are crossed at the connection portion 552 connecting the second portion 52 and the third portion 53, the direction of the induced voltage induced in the first portion 51 and the second portion 52 and that of the induced voltage induced in the third portion 53 and the fourth portion 54 are opposite when the intensity of the magnetic field in the direction perpendicular to the substrate 3 changes. This means that when a uniform alternating current magnetic field is applied to the entire first portion 51, the second portion 52, the third portion 53, and the fourth portion 54, the induced voltage induced in the first portion 51 and the second portion 52 and the induced voltage induced in the third portion 53 and the fourth portion 54 are offset.

In the same manner, the second detection coil 6 has a first portion 61, a second portion 62, a third portion 63, and a fourth portion 64, in which induced voltage is induced by the magnetic flux of the alternating current magnetic field of the excitation coil 4 chaining together, connection portions 651 to 653 which connect the first to fourth portions 61 to 64, and an output line portion 66 which outputs the induced voltage induced in the second detection coil 6. The output line portion 66 is used to output the induced voltage induced in the second detection coil 6. Each of the first to fourth portions 61 to 64 extends along the coil longitudinal direction which is parallel to the axial direction of the rack shaft 13, and at least a portion of each is aligned perpendicular to the coil longitudinal direction. In the present embodiment, the first to fourth portions 61 to 64 are equal in length in the coil longitudinal direction, and the entire first to fourth portions 61 to 64 in the coil longitudinal direction are aligned in a row perpendicular to the coil longitudinal direction.

The respective shapes of the first portion 61, the second portion 62, the third portion 63, and the fourth portion 64 of the second detection coil 6, viewed from a direction perpendicular to the substrate 3, are a pair of curved conductor wires with a quarter-wavelength cosine wave (a sine wave with a phase shift of 90°), which are combined in line symmetry across an axis of symmetry along the coil longitudinal direction. In FIG. 4B, these axes of symmetry 6L₁, 6L₂, 6L₃, and 6L₄ are shown as single dotted lines.

When the second detection coil 6 is viewed from the right side of the drawing in FIG. 4B toward the left side of the drawing, the first portion 61 and the third portion 63 gradually become narrower in the width direction perpendicular to the coil longitudinal direction, while the second portion 52 and the fourth portion 54 gradually become wider in the width direction perpendicular to the coil longitudinal direction. The shape of the first portion 61, the second portion 62, the third portion 63, and the fourth portion 64 when arranged in a row along the coil longitudinal direction is a cosine wave as a whole.

In the second detection coil 6, because the conductor wires are crossed at the connection portion 651 connecting the first portion 61 and the second portion 62, and at the connection portion 653 connecting the third portion 63 and the fourth portion 64, the direction of the induced voltage induced in the first portion 61 and the fourth portion 64 and the direction of the induced voltage induced in the second portion 62 and the third portion 63 are opposite when the intensity of the magnetic field in the direction perpendicular to the substrate 3 changes. This means that when a uniform alternating current magnetic field is applied to the first portion 61, the second portion 62, the third portion 63, and the fourth portion 64 entirely, the induced voltages induced in the first portion 61 and the fourth portion 64 and the induced voltages induced in the second portion 62 and third portion 63 are offset.

The induced voltage induced in the first detection coil 5 and the induced voltage induced in the second detection coil 6 are output to the calculation unit 8 via the respective output line portions 56, 66, the connector 91, and the cable 92. The calculation unit 8 calculates the position of the rack shaft 13 by the induced voltages induced in the first detection coil 5 and the second detection coil 6, and transmits the data on the position of the rack shaft 13 to the steering controller 19. The function of the calculation unit 8 may be realized by a CPU (central processing unit) mounted on the substrate 3. In this case, the CPU transmits the data on the position of the rack shaft 13 to the steering controller 19.

FIG. 3B shows the center points C₁, C₂, C₃, and C₄ on the facing surfaces 21a, 22a, 23a, 24a of the first to fourth detection target portions 21 to 24. A distance D₁ between the center point C₁ of the first detection target portion 21 and the center point C₂ of the second detection target portion 22, a distance D₂ between the center point C₂ of the second detection target portion 22 and the center point C₃ of the third detection target portion 23, and the distance D₃ between the center point C₃ of the third detection target portion 23 and the center point C₄ of the fourth detection target portion 24 are equal to a length L of the first detection coil 5 and the second detection coil 6 in the longitudinal direction of the substrate 3, excluding the output line portions 56, 66 (see FIG. 5). Hereinafter, the range on the substrate 3 where the first detection coil 5 and the second detection coil 6 are formed, excluding the output line portions 56, 66, is referred to as a “coil formation range.”

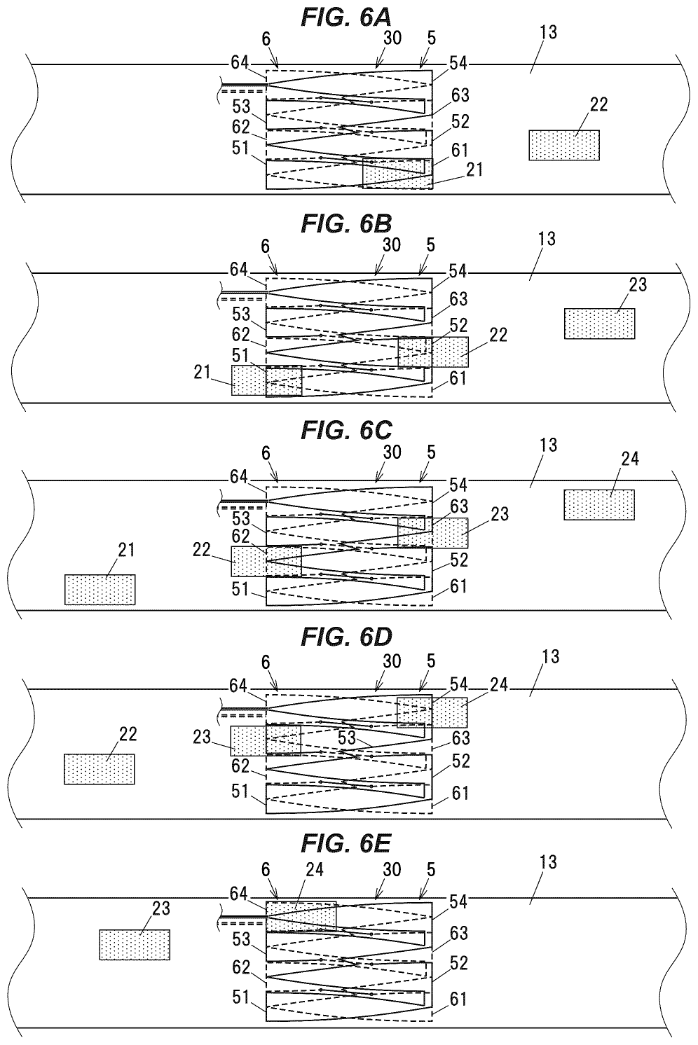

FIG. 6A through FIG. 6E illustrate the relative positional changes of the first and second detection coils 5, 6 and the first to fourth detection target portions 21 to 24, when the rack shaft 13 moves from the right side to the left side of the drawing with respect to the substrate 3. In FIG. 6A through FIG. 6E, the coil formation range is indicated by a reference numeral 30.

FIG. 6A shows the state of the rack shaft 13 when it is at one end of the predetermined range R in the axial direction, and FIG. 6E shows the state of the rack shaft 13 when it is at the other end of the predetermined range R in the axial direction. FIG. 6C shows the state when the rack shaft 13 is at the center of the predetermined range R (neutral position). Also, FIG. 6B shows the state when the rack shaft 13 is in a position between the position shown in FIG. 6A and the position shown in FIG. 6C, and FIG. 6D shows the state when the rack shaft 13 is in a position between the position shown in FIG. 6C and the position shown in FIG. 6E.

In the state shown in FIG. 6A, the entire first detection target portion 21 overlaps a coil formation range 30. In the state shown in FIG. 6B, each half of the first detection target portion 21 and the second detection target portion 22 overlap the coil formation range 30. In the state shown in FIG. 6C, each half of the second detection target portion 22 and the third detection target portion 23 overlap the coil formation range 30. In the state shown in FIG. 6D, each half of the third detection target portion 23 and the fourth detection target portion 24 overlap the coil formation range 30. In the state shown in FIG. 6E, the entire fourth detection target portion 24 overlaps the coil formation range 30.

In the present embodiment, since the distances D₁, D₂, and D₃ are equal to the length L of the coil formation range 30 as described above, the total length of the length of the first portions 51, 61 of the first detection coil 5 and the second detection coil 6 facing the first detection target portion 21, the length of the second portions 52, 62 of the first detection coil 5 and the second detection coil 6 facing the second detection target portion 22, the length of the third portions 53, 63 of the first detection coil 5 and the second detection coil 6 facing the third detection target portion 23, and the length of the fourth portion 54, 64 of the first detection coil 5 and the second detection coil 6 facing the fourth detection target portion 24, is regular (length L) in the axial direction of the rack shaft 13 in the entire predetermined range R.

The first detection target portion 21 at least partially faces the first portions 51, 61 of the first detection coil 5 and the second detection coil 6 in the first predetermined range of the predetermined range R. The second detection target portion 22 at least partially faces the second portions 52, 62 of the first detecting coil 5 and the second detecting coil 6 in the second predetermined range of the predetermined range R. The third detection target portion 23 at least partially faces the third portions 53, 63 of the first detecting coil 5 and the second detecting coil 6 in the third predetermined range of the predetermined range R. The fourth detection target portion 24 at least partially faces the fourth portions 54, 64 of the first detecting coil 5 and the second detecting coil 6 in the fourth predetermined range of the predetermined range R. In the axial direction of the rack shaft 13, the first and second predetermined ranges, the second and third predetermined ranges, and the third and fourth predetermined ranges overlap at their respective ends.

The induced voltage induced in the first portions 51, 61 of the first detection coil 5 and the second detection coil 6 varies according to the position of the first detection target portion 21 relative to the first portions 51, 61. The induced voltage induced in the second portions 52, 62 of the first detection coil 5 and the second detection coil 6 varies according to the position of the second detection target portion 22 relative to the second portions 52, 62. The induced voltage induced in the third portions 53, 63 of the first detection coil 5 and the second detection coil 6 varies according to the position of the third detection target portion 23 relative to the third portions 53, 63. The induced voltage induced in the fourth portions 54, 64 of the first detection coil 5 and the second detection coil 6 varies according to the position of the fourth detection target portion 24 relative to the fourth portions 54, 64. This allows the calculation unit 8 to determine the position of the rack shaft 13 by calculation over the entire predetermined range R.

In the first detection coil 5 and the second detection coil 6, an induced voltage of the same period as that of the alternating current supplied to the excitation coil 4 is induced, and the peak value of the induced voltage varies according to the position of the first to fourth detection target portions 21 to 24 relative to the substrate 3. The peak value of the induced voltage here refers to the maximum value of the absolute value of the induced voltage within one cycle of the alternating current supplied to the excitation coil 4.

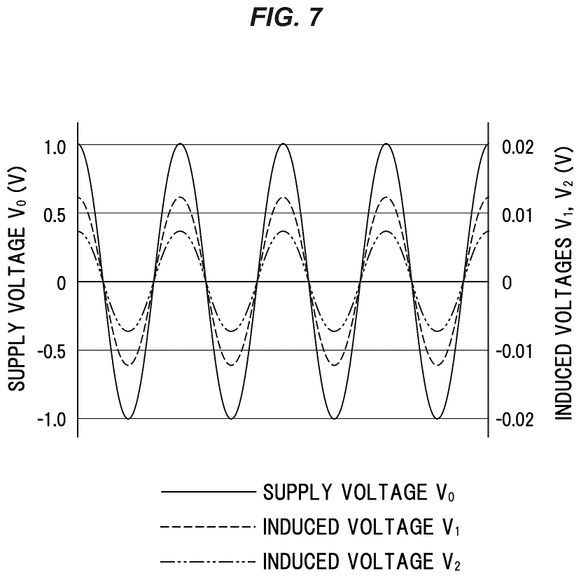

FIG. 7 shows an example of the relationship between the supply voltage V₀ supplied from the power supply unit 7 to the excitation coil 4, the induced voltage V₁ induced in the first detection coil 5 and the induced voltage V₂ induced in the second detection coil 6, when the first detection target portion 21 is facing the first portions 51, 61 of the first detection coil 5 and the second detection coils 6. The graph shows an example of the relationship between V₁ and V₂. The horizontal axis of the graph in FIG. 7 shows the time, and the left and right vertical axes show the supply voltage V₀ and the induced voltages V₁ and V₂ respectively. In the example shown in FIG. 7, the supply voltage V₀ and the induced voltages V₁ and V₂ are in phase, but one or both of the induced voltages V₁ and V₂ are in opposite phase to the supply voltage V₀, depending on the position of the detection target 2 relative to the substrate 3.

FIG. 8 is a graph showing the relationship between a peak voltage Vs, which is a peak value of the induced voltage V₁ induced in the first detection coil 5, and the position of the detection target 2. FIG. 9 is a graph showing the relationship between the peak voltage Vc, which is a peak value of the induced voltage V₂ induced in the second detection coil 6, and the position of the detection target 2. The horizontal axis of the graphs in FIG. 8 and FIG. 9 indicates the position of the detection target 2. In the graph shown in FIG. 8, the peak voltage Vs of the first detection coil 5 has a positive value when the induced voltage V₁ induced in the first detection coil 5 is in phase with the voltage V₀ supplied to the excitation coil 4, and has a negative value when it is in opposite phase (i.e., 180 degrees phase shifted). In the graph in FIG. 9, the peak voltage Vc of the second detection coil 6 has a positive value when the induced voltage V₂ induced in the second detection coil 6 is in phase with the voltage V₀ supplied to the excitation coil 4, and has a negative value when it is in opposite phase.

On the horizontal axis of the graphs in FIG. 8 and FIG. 9, P₀ represents the position of the detection target 2 when the rack shaft 13 is in the neutral position, P₁ represents the position of the detection target 2 in the state shown in FIG. 6A, and P₂ represents the position of the detection target 2 in the state shown in FIG. 6E. As shown in FIG. 8 and FIG. 9, the peak voltage Vs and the peak voltage Vc are never the same in the range from P₁ to P₂. This allows the calculation unit 8 to instantly determine an absolute position of the rack shaft 13 based on the peak voltage Vs and the peak voltage Vc.

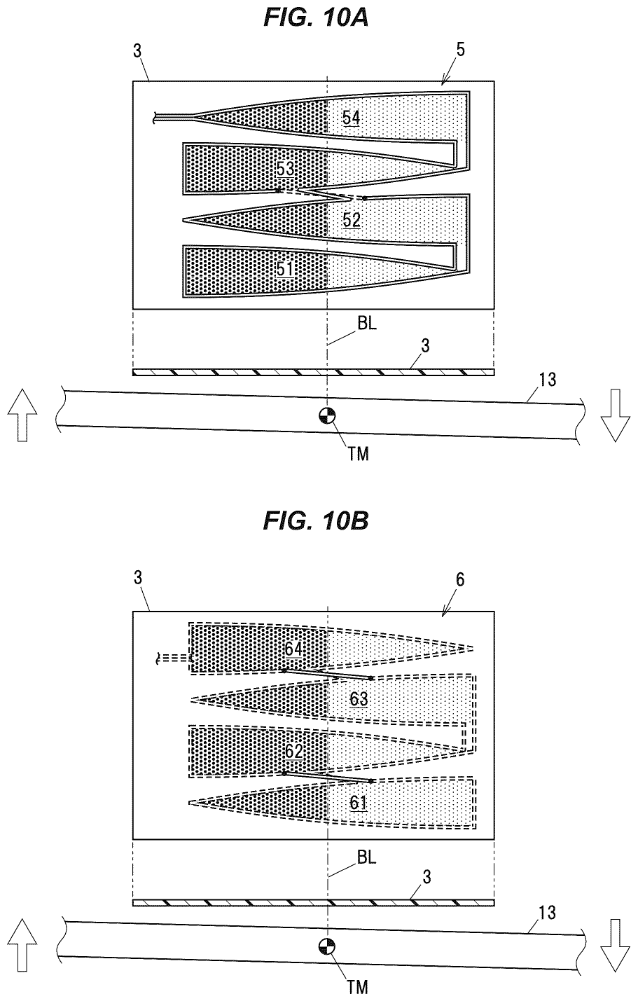

By the way, if the rack shaft 13 tilts against the substrate 3 due to vibration during vehicle running, for example, the distance between the substrate 3 and the rack shaft 13 changes, which varies the degree to which the rack shaft 13 and the detection target 2 affect the intensity distribution of the magnetic flux in the excitation coil 4, depending on the position of the substrate 3 in the longitudinal direction. In the present embodiment, the influence of the inclination of the rack shaft 13 on the detection accuracy of the position of the detection target 2 is suppressed by the configuration in which the first portions 51, 61, the second portions 52, 62, the third portions 53, 63, and the fourth portions 54, 64 of the first detection coil 5 and the second detection coil 6 are arranged in the shortitudinal direction of the substrate 3. Next, the functions and effects of this configuration will be explained with reference to FIG. 10.

FIG. 10A is an explanatory diagram schematically showing the relationship between the inclination of the rack shaft 13 relative to the substrate 3 and the effect of the inclination of the rack shaft 13 on the magnetic flux density chained to the first detection coil 5. FIG. 10B is an explanatory diagram schematically showing the relationship between the inclination of the rack shaft 13 relative to the substrate 3 and the effect of the inclination of the rack shaft 13 on the magnetic flux density chained to the second detection coil 6. In FIG. 10A and FIG. 10B, a bisector BL in the coil longitudinal direction of the first detection coil 5 and the second detection coil 6 is shown as a dashed-double-dotted line, and the rack shaft 13 is tilted in the vertical direction in the drawing around the point indicated by a target mark TM on the bisector BL. The rack shaft 13 and the detection target 2 are tilted so that a part in dark gray of the drawing on the left of the target mark TM is closer to the substrate 3, and a part in light gray of the drawing on the right of the target mark TM is farther away from the substrate 3. In FIG. 10A and FIG. 10B, the inclination of the rack shaft 13 is exaggerated.

In the present embodiment, the first portions 51, 61, the second portions 52, 62, the third portions 53, 63, and the fourth portions 54, 64 of the first detection coil 5 and the second detection coil 6 are aligned in the shortitudinal direction of the substrate 3. This configuration makes the length L of the coil formation range 30 in the axial direction of the rack shaft 13 shorter than, for example, that of the coil described in Patent Literature 1. As a result, even if the rack shaft 13 is tilted, changes in the width W of the air gap G (see FIG. 2) and the distance between the rack shaft 13 and the substrate 3 are kept small, and the peak voltage Vs and the peak voltage Vc are hardly changed. This makes it possible to detect the position of the rack shaft 13 with high accuracy.

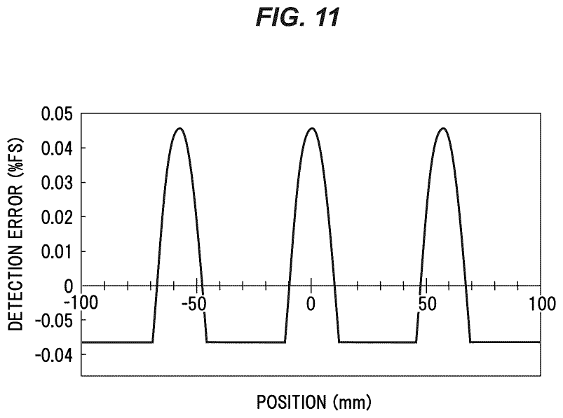

FIG. 11 is a graph showing the evaluation results of detection errors when the position of the rack shaft 13 is detected by the stroke sensor 1 according to the embodiment of the present invention. The horizontal axis of the graph shows the movement amount of the rack shaft 13 when the neutral position of the rack shaft 13 is defined to be “0” (mm). The vertical axis of the graph shows the detection errors of the position of the rack shaft 13 when the rack shaft 13 is tilted by 0.5° in % FS (FS means full scale).

As shown in FIG. 11, the stroke sensor 1 has a maximum detection error (% FS) of about 0.04% when the rack shaft 13 is in the position shown in FIG. 6B, FIG. 6C, and FIG. 6D, but the overall detection errors are controlled to 0.05% or be low, ensuring sufficient detection accuracy.

### SUMMARY OF THE EMBODIMENTS

Next, technical ideas understood from the above embodiment, will be described with reference to the reference numerals and the like used in the embodiment. However, each reference numeral in the following description does not limit the constituent elements in the scope of claims to the members and the like specifically shown in the embodiments.

According to the first feature, a position detection device 1 (stroke sensor 1) for detecting the position of a shaft (rack shaft 13) that moves forward and backward in the axial direction in a predetermined range R includes an excitation coil 4 that generates an alternating current magnetic field; a detection target 2 fixed to the shaft 13 and on which the magnetic flux of the alternating current magnetic field is chained together; and detection coils 5, 6 in which the magnetic flux of the alternating current magnetic field is chained together, wherein the detection coils 5, 6 have first to fourth portions 51 to 54, 61 to 64 in which an induced voltage is induced by the magnetic flux of the AC magnetic field chained together and connection portions 551 to 553, 651 to 653 connecting the first to fourth portions 51 to 54, 61 to 64, wherein the first to fourth portions 51 to 54, 61 to 64 respectively extending along the coil longitudinal direction which is parallel to the axial direction and at least a portion of each being aligned in a direction perpendicular to the coil longitudinal direction, wherein the detection target 2 has a first detection target portion 21 at least partially facing the first portions 51, 61 in a first predetermined range of the predetermined range R, a second detection target portion 22 at least partially facing the second portions 52, 62 in a second predetermined range of the predetermined range R, a third detection target portion 23 at least partially facing the third portions 53, 63 in a third predetermined range of the predetermined range R, and the fourth detection target portion 24 at least partially facing the fourth portions 54, 64 in a fourth predetermined range of the predetermined range R, wherein the induced voltage induced in the first to fourth portions 51 to 54, 61 to 64 varies depending on the position of the first to fourth detection target portions 21 to 24 relative to the first to fourth portions 51 to 54, 61 to 64, and wherein the first detection target portion 21, the second detection target portion 22, the third detection target portion 23, and the fourth detection target portion 24 are spaced apart in the axial direction of the shaft 13.

According to the second feature, in the position detection device as described by the first feature, the first predetermined range and the second predetermined range, the second predetermined range and the third predetermined range, and the third predetermined range and the fourth predetermined range overlap at their respective ends in the axial direction of the shaft 13.

According to the third feature, in the position detection device 1 as described by the second feature, the sum of lengths of a length of the first portions 51, 61 and the first detection target portion 21 facing each other, a length of the second portions 52, 62 and the second detection target portion 22 facing each other, a length of the third portions 53, 63 and the third detection target portion 23 facing each other, and a length of the fourth portions 54, 64 and the fourth detection target portion 24 facing each other, is constant over the entire predetermined range R in the axial direction of the shaft 13.

According to the fourth feature, in the position detection device 1 as described by any one of the first to third features, each of the first to fourth portions 51 to 54, 61 to 64 has the same length in the coil longitudinal direction, and wherein the first to fourth portions 51 to 54, 61 to 64 are arranged in a row along an alignment direction perpendicular to the coil longitudinal direction.

According to the fifth feature, in the position detection device as described by any one of the first to third features, the first to fourth portions 51 to 54, 61 to 64 are shaped as a combination of a pair of sinusoidal conductor lines symmetrical across the axes of symmetry 5L₁, 5L₂, 5L₃, 5L₄, 6L₁, 6L₂, 6L₃, 6L₄ that extend in the coil longitudinal direction.

According to the sixth feature, in the position detection device 1 as described by the fifth feature, the magnitude of the induced voltage induced in the detection coils 5, 6 varies in a range of one cycle or less while the shaft 13 moves from one end of the predetermined range R to the other end of the predetermined range R.

According to the seventh feature, in the position detection device 1 as described by the sixth feature, the detection coil 5, 6 includes two detection coils 5, 6, wherein the phases of the induced voltages induced in each of the two detection coils 5, 6 while the shaft 13 is moving from one end of the predetermined range R to the other end of the predetermined range R, are different from each other.

According to the eighth feature, in the position detection device 1 as described by the seventh feature, the excitation coil 4 and the two detection coils 5, 6 are formed on a single substrate 3, and wherein the two detection coils 5, 6 are stacked in the thickness direction of the substrate 3.

The above description of the embodiments of the invention does not limit the invention to the scope of the claims. Additionally, it should be noted that not all the combinations of features described in the embodiments are essential to the means for solving the problems of the invention. Furthermore, the invention can be implemented by modifying it as appropriate to the extent that it does not depart from the intent of the invention, for example, it can be implemented by modifying it as follows.

The above embodiment describes the case in which the first detection target portion 21, the second detection target portion 22, the third detection target portion 23, and the fourth detection target portion 24 are arranged protruding from the rack shaft 13 toward the substrate 3. However, the present invention is not limited thereto. The detection target 2 may be made flat in the axial direction of the rack shaft 13, and the first to fourth detection target portions 21 to 24 may be formed as recesses or notches, for example. Even in this case, the position of the rack shaft 13 can be detected in the same way as in the above embodiment, since the magnetic flux density changes between the portions facing the first to fourth detection target portions 21 to 24 and the portions not facing them.

The above embodiment describes the case in which the conductor lines of the first portions 51, 61, the second portions 52, 62, the third portions 53, 63, and the fourth portions 54, 64 of the first detection coil 5 and the second detection coil 6 are sine curve shaped, but not limited to this, they may be triangular wave shaped, for example. Furthermore, the excitation coil 4 as well as the first and second detection coils 5, 6 do not necessarily have to be formed on the substrate.

1. A position detection device for detecting the position of a shaft that moves forward and backward in an axial direction in a predetermined range, comprising:
an excitation coil that generates an alternating current magnetic field;
a detection target fixed to the shaft and in which the magnetic flux of the alternating current magnetic field is chained together; and
a detection coil in which the magnetic flux of the alternating current magnetic field is chained together,
wherein the detection coil has first to fourth portions where an induced voltage is induced by the magnetic flux of the alternating current magnetic field chained together, and connection portions connecting the first to fourth portions,
wherein the first to fourth portions each extend along a coil longitudinal direction which is parallel to the axial direction, and at least a portion of each is aligned perpendicular to the coil longitudinal direction,
wherein the detection target has a first detection target portion at least partially facing the first portion in a first predetermined range of the predetermined range, a second detection target portion at least partially facing the second portion in a second predetermined range of the predetermined range, a third detection target portion at least partially facing the third portion in a third predetermined range of the predetermined range, and a fourth detection target portion at least partially facing the fourth portion in a fourth predetermined range of the predetermined range,
wherein the induced voltage induced in the first to fourth portions varies with the position of the first to fourth detection target portions relative to the first to fourth portions respectively, and
wherein the first detection target portion, the second detection target portion, the third detection target portion, and the fourth detection target portion are spaced apart in the axial direction of the shaft.

2. The position detection device according to claim 1, wherein the first predetermined range and the second predetermined range, the second predetermined range and the third predetermined range, and the third predetermined range and the fourth predetermined range overlap at their respective ends in the axial direction of the shaft.

3. The position detection device according to claim 2, wherein a sum of lengths of a length of the first portion and the first detection target facing each other, a length of the second portion and the second detection target facing each other, a length of the third portion and the third detection target facing each other, and a length of the fourth portion and the fourth detection target facing each other in the axial direction of the shaft is constant over an entire predetermined range.

4. The position detection device according to claim 1, wherein the lengths of the first to fourth portions are equal in the coil longitudinal direction, and
wherein the first to fourth portions are aligned in a row along an alignment direction perpendicular to the coil longitudinal direction.

5. The position detection device according to claim 1, wherein the first to fourth portions are shaped as a combination of a pair of sinusoidal conductor wires respectively, which is symmetrical across an axis of symmetry extending in the coil longitudinal direction.

6. The position detection device according to claim 5, wherein a magnitude of the induced voltage induced in the detection coil changes in a range of one cycle or less while the shaft moves from one end of the predetermined range to an other end of the predetermined range.

7. The position detection device according to claim 6, wherein the detection coil comprises two detection coils, and
wherein the phases of the induced voltages induced in the two detection coils are different from each other while the shaft moves from one end of the predetermined range to the other end of the predetermined range.

8. The position detection device according to claim 7, wherein the excitation coil and the two detection coils are formed on a single substrate, and
wherein the two detection coils are stacked in a thickness direction of a substrate.
